(19) United States
(12) Patent Application Publication
(10) Pub. No.: US 2021/0352952 A1
(43) Pub. Date: Nov. 18, 2021

(54) CAPSULE CONTAINING PURE (ABOUT 100%) STEVIA EXTRACT

(71) Applicant: REELPUR INC., Mercier (CA)

(72) Inventor: Ferdinand TCHOUNKEU, Mercier (CA)

(21) Appl. No.: 17/303,420

(22) Filed: May 28, 2021

Related U.S. Application Data
(63) Continuation-in-part of application No. 15/755,183, filed on Feb. 26, 2018, now abandoned.
(60) Provisional application No. 62/403,898, filed on Oct. 4, 2016.

(51) Int. Cl. A23P 10/30; A23P 10/20; A23L 27/30

(52) U.S. Cl. CPC A23P 10/30; A23V 2002/00; A23L 27/33; A23P 10/20

(57) ABSTRACT

A capsule containing a single ingredient which is 100% pure stevia extract in tamped powder form. The content of the capsule has a sweetness which is equivalent to the sweetness of a sugar cube or a tablespoon of sugar. The stevia extract is obtained by a process comprising a step of tamping bulk 100% pure stevia extract powder and inserting the tamped powder into the capsule.

### FIELD OF THE INVENTION

The present invention relates generally to the presentation and packaging of sweeteners. More specifically, the present invention relates to a capsule containing 100% pure stevia extract as single ingredient, in tamped powder form. In embodiments of the invention, the content of the capsule has a sweetness which is equivalent to the sweetness a sugar cube or tablespoon.

### BACKGROUND OF THE INVENTION

Stevia extract is about 300 (200-400) times sweeter than sucrose or saccharose, the standard sugar commonly used. Typically, a sugar cube or a tablespoon (tsp) of sugar weights about 4000-5000 mg (4-5 g). Accordingly, in order to have the same sweetness provided by a sugar cube or a tablespoon of sugar, an amount of about 13.5-16.5 mg (in a range of 12.5-25 mg depending of the stevia type and sweetness) of pure stevia extract should be used. Such amount is too small, and thus presents some challenges related to packaging and handling, when it is desired to making available to consumers pure stevia extract for use in a manner similar to the use of sugar cubes or tsp sugar. Making available to consumers a portioned pure stevia extract would need an amount far greater than its sugar equivalent, which would lead to a product that is too sweet, inedible and even unhealthy.

A solution known in the art is to add other ingredients or fillers to the stevia extract, such as to increase the weight of the product, which allows for packaging and handling with relative ease. Such products typically weight 600-3000 mg, which is about 24-240 times the weight of a 100% pure portioned stevia extract (12.5-25 mg). A portioned 100% pure stevia extract of a similar weight, i.e., 600-3000 mg would be inedible and unhealthy for consumers. The fillers and other ingredients are used not only to adjust the taste but mainly to facilitate prepackaging of portioned stevia extract as indicated above. Examples of such products currently found on the market are presented in FIG. 1. And as can be seen in FIG. 2, the product typically includes at least about 2 to 5 additional ingredients in addition to the stevia extract. As a result, the actual stevia extract represents less than about 2 to 5% of the final product. The added ingredients or fillers are generally erythritol, dextrose, maltodextrine, etc.

The inventor is aware of the following documents: U.S. Pat. No. 6,610,337; U.S. 2007/0071808; U.S. 2008/0213320 of Eisenstein et al.; U.S. 2010/0112101 of Gokaraju et al.; U.S. 2010/0239638 of Shodai et al.; U.S. 2012/0070533 of Shi; WO 2017/066134; U.S. Pat. Nos. 10,779,684; 10,399,721; 10,398,693.

There is a need to making available to consumers products consisting of 100% pure stevia extract. Also, there is a need to making available to consumers portioned 100% pure stevia extract products.

### SUMMARY OF THE INVENTION

The inventor has designed a presentation and packaging that allows for the use of 100% pure stevia extract as tabletop sweetener. The invention allows for the use of 100% pure stevia extract in an amount yielding a sweetness which is readily comparable to the sweetness of a sugar cube or tablespoon. The product according to the invention, herein also referred to as ReelPur™, is presented in the form of a capsule.

In embodiments of the invention, the 100% pure stevia extract in the capsule is in the form of a tamped powder. Accordingly, the process of obtaining it comprises a step of tamping bulk 100% pure stevia extract powder and inserting the tamped powder into the capsule. Optionally, the process comprises a physical granulation step which is performed prior to the tamping step.

More specifically, the present invention provides the following according to aspects thereof:
(1) A capsule containing a stevia extract.
(2) A capsule containing a stevia extract that is about 100% pure.
(3) A capsule containing a stevia extract that is about 100% pure, wherein the content of the capsule has a sweetness which is equivalent to the sweetness of a sugar cube or tablespoon.
(4) A capsule containing a stevia extract that is about 100% pure, wherein the amount of the stevia extract in the capsule is between about 6 to 8 mg, preferably between about 8 to 10 mg, preferably between about 10 to 12 mg, preferably between about 12 to 14 mg, preferably between about 13 to 15 mg, preferably between about 13.5 to 16.5 mg, preferably between about 14 to 17 mg, preferably between about 15 to 19 mg, preferably between about 16 to 20 mg, preferably between about 17 to 21 mg, preferably between about 18 to 22 mg, preferably between about 19 to 23 mg, preferably between about 20 to 24 mg, preferably between about 21 to 25 mg, preferably between about 22 to 26 mg, or preferably between about 6.5 to 8.5 mg, etc.
(5) A capsule containing a stevia extract that is about 100% pure, wherein the amount of the stevia extract in the capsule is between about 13.5 to 16.5 mg.
(6) A capsule containing a stevia extract that is about 100% pure, wherein the amount of the stevia extract in the capsule is between about a multiple of the amount 13.5 to 16.5 mg, for example 27 to 33 mg, 40.5 to 49.5 mg, 54 to 66 mg, etc.
(7) A capsule containing a stevia extract that is about 100% pure, wherein the amount of the stevia extract in the capsule is between about 6.5 to 8.5 mg.
(8) A capsule according to any one of (1) to (7) above, wherein the stevia extract is in a form selected from the group consisting of: powder, liquid, granular, pieces of dry leaf, and combinations thereof.
(9) A capsule according to any one of (1) to (7) above, wherein the stevia extract is in powder form.
(10) A capsule according to any one of (1) to (7) above, further comprising a component selected from the group consisting of nutritional supplement, vitamins, flavours; optionally, the amount of the stevia extract in the capsule is more than about 60% by weight.
(11) A capsule according to any one of (1) to (7) above, wherein the capsule is made of a material selected from the group consisting of: hydroxypropyl methyl cellulose (HPMC) hydroxymethyl cellulose (HMC), gelatin, pullulan naturally fermented from tapioca, vegetable-based material, and combinations thereof.
(12) A capsule according to any one of (1) to (7) above, wherein the capsule is made of a material that is bio-degradable.
(13) A capsule according to any one of (1) to (7) above, wherein the capsule is made of a material that is soluble in aqueous medium.
(14) A capsule according to any one of (1) to (7) above, wherein the capsule is made of a material that is not soluble in aqueous medium.
(15) A capsule according to any one of (1) to (7) above, wherein the capsule is adapted to be operated manually by a user, such as to release the stevia extract.
(16) A capsule according to any one of (1) to (7) above, wherein the capsule has an elongated spherical shape, and has a length between about 7 to 100 mm and a width between about 3 to 28 mm; preferably a length between about 10 to 90 mm and a width between about 4 to 25 mm; preferably a length between about 11.1 to 88.5 mm and a width between about 4.91 to 23.4 mm.
(17) A capsule according to any one of (1) to (7) above, wherein the capsule has an elongated spherical shape, and has a length between about 11.1 to 88.5 mm and a width between about 4.91 to 23.4 mm.
(18) A capsule according to any one of (1) to (7) above, having a size between about 5 to Su07.
(19) A capsule according to any one of (1) to (18) above, wherein the capsule has a color selected from the group consisting of: white, green, brown, colourless, yellow, red, blue, black, ivory, orange, grey, pink, pearly blue, and combinations thereof; optionally the capsule is opaque or transparent.
(20) A capsule according to any one of (1) to (19) above, having a sign printed on an external surface thereof; optionally the sign is selected from the group consisting of: image of a human face, image of an object, group of letters, words, and combinations thereof.
(21) A container comprising a stevia extract.
(22) A container comprising a stevia extract that is about 100% pure.
(23) A portioned stevia extract.
(24) A portioned stevia extract that is about 100% pure.
(25) A method of making available to consumers a stevia extract, the method comprising: providing the stevia extract; providing a capsule; and filling up the capsule with the stevia extract.
(26) A method of making available to consumers a stevia extract that is about 100% pure, the method comprising: providing the stevia extract that is about 100% pure; providing a capsule; and filling up the capsule with the stevia extract that is about 100% pure.
(27) A method of making available to consumers a stevia extract that is about 100% pure, the method comprising: providing the stevia extract that is about 100% pure; providing a capsule; and filling up the capsule with the stevia extract that is about 100% pure, wherein the content of the capsule has a sweetness which is equivalent to the sweetness of a sugar cube or tablespoon.
(28) A method of making available to consumers a stevia extract that is about 100% pure, the method comprising: providing the stevia extract that is about 100% pure; providing a capsule; and filling up the capsule with the stevia extract that is about 100% pure, wherein an amount of the stevia extract is between about 6 to 8 mg, preferably between about 8 to 10 mg, preferably between about 10 to 12 mg, preferably between about 12 to 14 mg, preferably between about 13 to 15 mg, preferably between about 13.5 to 16.5 mg, preferably between about 14 to 17 mg, preferably between about 15 to 19 mg, preferably between about 16 to 20 mg, preferably between about 17 to 21 mg, preferably between about 18 to 22 mg, preferably between about 19 to 23 mg, preferably between about 20 to 24 mg, preferably between about 21 to 25 mg, preferably between about 22 to 26 mg, or preferably between about 6.5 to 8.5 mg, etc.
(29) A method of making available to consumers a stevia extract that is about 100% pure, in an amount yielding a sweetness which is equivalent to the sweetness of a sugar cube or tablespoon, the method comprising: providing the stevia extract that is about 100% pure; providing a capsule; and filling up the capsule with the stevia extract that is about 100% pure, wherein the amount is between about 13.5 to 16.5 mg.
(30) A method of making available to consumers a stevia extract that is about 100% pure, in an amount yielding a sweetness which is equivalent to the sweetness of half a sugar cube or tablespoon, the method comprising: providing the stevia extract that is about 100% pure; providing a capsule; and filling up the capsule with the stevia extract that is about 100% pure, wherein the amount is between about 6.5 to 8.5 mg.
(31) A method of using a stevia extract, comprising manually operating a capsule as defined in any one of (1) to (20) above, such as to release the stevia extract for use, for example in a container (cup) containing food (in solid or liquid form).
(32) A package comprising one or more capsules as defined in any one of (1) to (20) above.
(33) A container comprising a plurality of capsules as defined in any one of (1) to (20) above, wherein the container is readily manually operable by a user, such as to release one or more capsules; optionally, the user uses both hands for the operation or a single hand.
(34) A container according to (33) above, which is a capsule distributor.
(35) A kit comprising: one or more container as defined in (21) or (22) above; and one or more container as defined in (33) or (34) above.
(36) A kit comprising: one or more container as defined in (21) or (22) above; one or more container as defined in (33) or (34) above; and one or more package as defined in (32) above.
(37) A kit according to (35) or (36) above, further comprising a device for retrieving a desired amount of the stevia extract from the one or more container as defined in (21) or (22) above; optionally, the device is a spoon.
(38) A kit according to any one of (35) to (37) above, further comprising instructions for use.

According to an aspect, the invention provides for a capsule containing a single ingredient which is 100% pure stevia extract in tamped powder form, wherein 90% of particles have sizes up to about 724.84 microns, wherein the content of the capsule has a sweetness which is equivalent to the sweetness of a sugar cube or a tablespoon of sugar, and wherein the stevia extract is obtained by a process comprising a step of tamping bulk 100% pure stevia extract powder and inserting the tamped powder into the capsule.

According to another aspect, the invention provides for a capsule containing a single ingredient which is 100% pure stevia extract in a tamped powder form, wherein 90% of particles have sizes up to about 724.84 microns; wherein the amount of the stevia extract in the capsule is: between about 6 to 8 mg, between about 8 to 10 mg, between about 10 to 12 mg, between about 12 to 14 mg, between about 13 to 15 mg, between about 13.5 to 16.5 mg, between about 14 to 17 mg, between about 15 to 19 mg, between about 16 to 20 mg, between about 17 to 21 mg, between about 18 to 22 mg, between about 19 to 23 mg, between about 20 to 24 mg, between about 21 to 25 mg, between about 22 to 26 mg, or between about 6.5 to 8.5 mg; and wherein the stevia extract is obtained by a process comprising a step of tamping bulk 100% pure stevia extract powder and inserting the tamped powder into the capsule.

According to yet another aspect, the invention provides for a portioned single ingredient which is 100% pure stevia extract in tamped powder form, having a sweetness which is equivalent to the sweetness of a sugar cube or a tablespoon of sugar; and wherein 90% of particles of the stevia extract have sizes up to about 724.84 microns; and wherein the stevia extract is obtained by a process comprising a step of tamping bulk 100% pure stevia extract powder.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1: Sample of stevia products currently available on the market.

FIG. 2: Sample of stevia products currently available on the market, including ingredients list.

FIG. 3: The stevia extract according to the invention, in powder form and capsules containing same.

FIG. 4A: Capsule according to the invention containing pure (about 100%) stevia extract. FIG. 4B: Capsule according to the invention in closed form (two capsules on the left) and opened form (one capsule on the right).

FIG. 5: Capsules according to the invention.

FIGS. 6A-6D: Particle size of the product according to the invention in powder form.

FIG. 7: Containers according to the invention.

FIG. 8A: Process for obtaining a stevia extract according to the prior art. FIG. 8B: Process for obtaining the capsule according to the invention.

FIG. 9: Process for obtaining the capsule according to the invention further illustrating the tamping process.

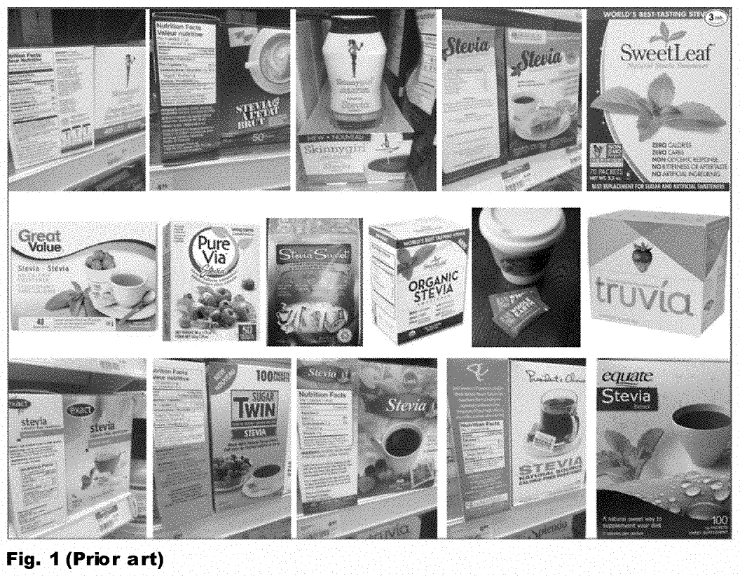

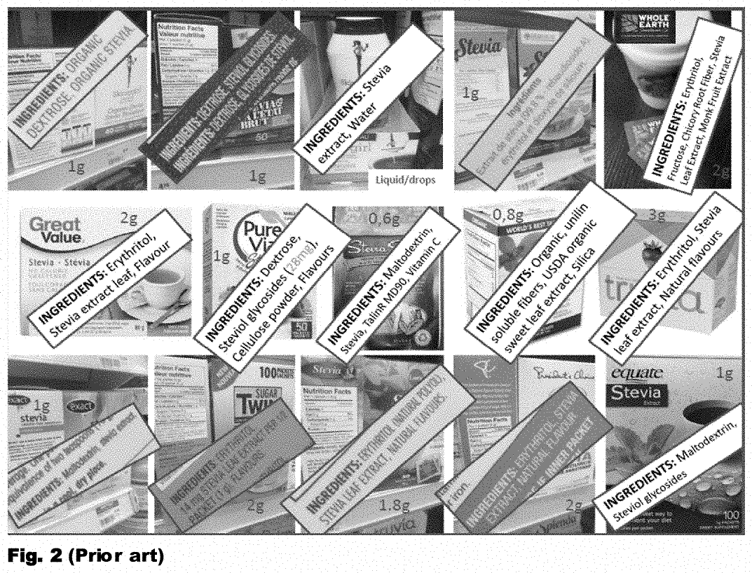

### DESCRIPTION OF ILLUSTRATIVE EMBODIMENTS

Before the present invention is further described, it is to be understood that the invention is not limited to the particular embodiments described below, as variations of these embodiments may be made and still fall within the scope of the appended claims. It is also to be understood that the terminology employed is for the purpose of describing particular embodiments; and is not intended to be limiting. Instead, the scope of the present invention will be established by the appended claims.

In order to provide a clear and consistent understanding of the terms used in the present specification, a number of definitions are provided below. Moreover, unless defined otherwise, all technical and scientific terms as used herein have the same meaning as commonly understood to one of ordinary skill in the art to which this disclosure pertains.

Use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

As used herein when referring to numerical values or percentages, the term “about” includes variations due to the methods used to determine the values or percentages, statistical variance and human error. Moreover, each numerical parameter in this application should at least be construed in light of the number of reported significant digits and by applying ordinary rounding techniques.

As used herein, the term “physical granulation” refers to the process of treating a 100% pure stevia extract powder such as to yield a 100% pure stevia extract powder having higher particle sizes. In embodiments of the invention, physical granulation is performed in conjunction with tamping (defined herein below), yielding a more granulated powder. This helps ease the packaging process and use of the final product.

As used herein, the term “tamping” refers to the process of compacting a 100% pure stevia extract powder such as to yield a 100% pure stevia extract powder having higher particle sizes. The tamping process is performed directly on a bulk 100% pure stevia extract powder. Alternatively, the tamping process is performed after a physical granulation process is performed, yielding a 100% pure stevia extract powder having even higher particle sizes. The tamped 100% pure stevia extract powder obtained is suitable for being portioned. For example, a desired amount is inserted into a capsule. The desired amount may be an amount providing a sweetness which corresponds to the sweetness of one sugar cube or one tablespoon of sugar. As will be understood by a skilled person, inserting an equivalent amount of bulk 100% pure stevia extract powder into a capsule without performing the tamping process or a combination of granulation and tamping, presents significant challenges, given the particularly low density of bulk 100% pure stevia extract powder.

The inventor has designed a presentation and packaging that allows for the use of 100% pure stevia extract as tabletop sweetener. The invention allows for the use of 100% pure stevia extract in an amount yielding a sweetness which is equivalent to the sweetness of a sugar cube or tablespoon. In embodiments of the invention, the product is presented in the form of a capsule.

In embodiments of the invention, the 100% pure stevia extract in the capsule is in the form of a tamped powder, which is obtained by a process comprising a step of tamping bulk 100% pure stevia extract powder and inserting the tamped powder into the capsule. Optionally, the process comprises a physical granulation step which is performed prior to the tamping step.

In embodiments of the invention, the tamping process is conducted using a system which embodies a powder chamber comprising a closing plate, and a pestle.

The present invention is illustrated in further details by the following non-limiting embodiments.

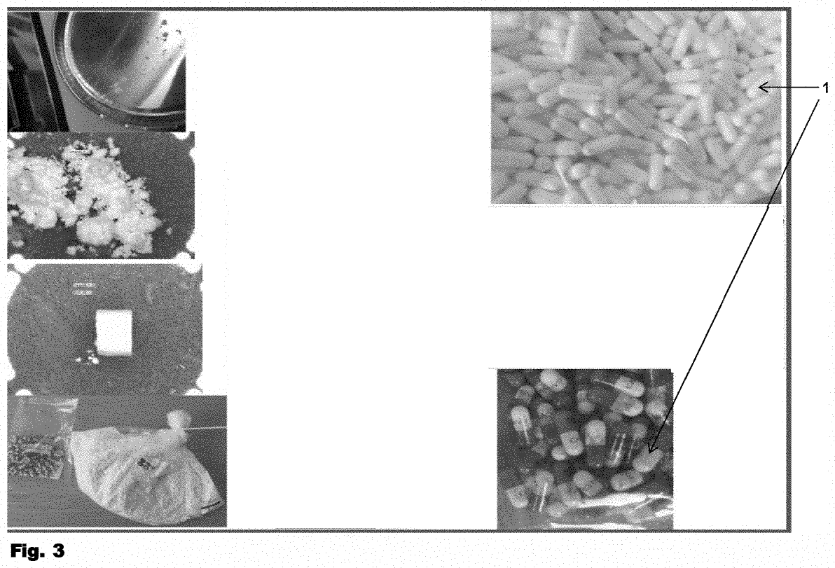

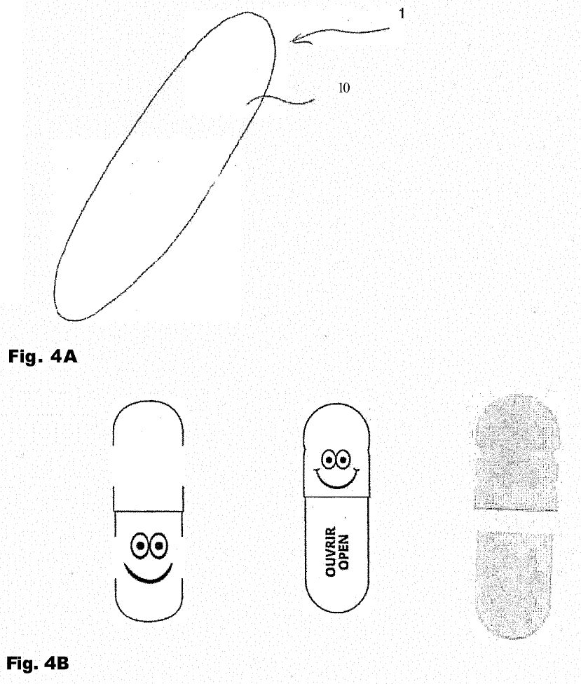

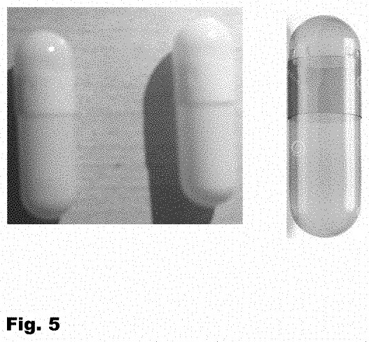

Referring to FIG. 3 and FIG. 4A, in order to offer a portioned 100% stevia extract, pure extract of stevia 10 is filled in capsules 1, using a specific filling equipment. The trials were first performed at 6 mg and then at 18 mg. The performance showed a standard deviation (SD) of ±0.1 mg (for the target of 6 mg) and ±0.33 mg (for the target of 18 mg). This performance is acceptable even when compared to standards in the pharmaceutical industry (Tables 1-3 below). This allows for the possibility of offering to consumers, a portioned 100% stevia extract. The product is presented in capsules (FIG. 3, FIG. 4A, FIG. 4B and FIG. 5), and the content 10 of a capsule 1 yields a sweetness equivalent to the sweetness of a sugar cube or tablespoon of sugar. The capsule used is designed to be easily and safely opened for sprinkling of stevia extract on to food or beverage.

TABLE 1
Weight trials (6 mg)

| Total Weight | =814.68 mg | | | |
|---|---|---|---|---|
| Target | 6 | 6 | 6 | 6 |
| Max. | 5.93 | 5.85 | 6.38 | 6.13 |
| Min. | 5.4 | 5.53 | 5.87 | 5.7 |
| Avg. | 5.75 | 5.68 | 6.06 | 5.79 |
| Diff. | 0.53 | 0.32 | 0.51 | 0.43 |
| SD | 0.100 | 0.088 | 0.128 | 0.079 |
| Results | =5.75 ± 0.1 | =5.68 ± 0.1 | =6.06 ± 0.1 | =5.79 ± 0.1 |

TABLE 2
Weight test stevia capsules (6 mg)
Weight Test Stevia capsules 6 mg

| | Weight mg | Weight mg | Weight mg | Weight mg |
|---|---|---|---|---|
| | Run 1 | Run 2 | Run 3 | Run 4 |
| 1 | 5.9 | 5.58 | 6.14 | 5.88 |
| 2 | 5.65 | 5.54 | 6.33 | 5.77 |
| 3 | 5.79 | 5.64 | 6.24 | 5.72 |
| 4 | 5.72 | 5.76 | 6.04 | 5.8 |
| 5 | 5.74 | 5.77 | 6.08 | 5.71 |
| 6 | 5.71 | 5.57 | 6.02 | 5.91 |
| 7 | 5.77 | 5.64 | 5.95 | 5.72 |
| 8 | 5.86 | 5.61 | 6.29 | 5.73 |
| 9 | 5.93 | 5.7 | 5.87 | 5.85 |
| 10 | 5.4 | 5.64 | 6.26 | 5.74 |
| 11 | 5.82 | 5.77 | 6.21 | 5.88 |
| 12 | 5.8 | 5.56 | 6.01 | 5.73 |
| 13 | 5.71 | 5.82 | 5.94 | 5.76 |
| 14 | 5.78 | 5.72 | 6.14 | 5.75 |
| 15 | 5.77 | 5.72 | 6.21 | 5.73 |
| 16 | 5.8 | 5.85 | 5.97 | 5.74 |
| 17 | 5.79 | 5.79 | 6.06 | 5.82 |
| 18 | 5.72 | 5.78 | 6.07 | 5.83 |
| 19 | 5.85 | 5.6 | 6.28 | 5.79 |
| 20 | 5.85 | 5.76 | 6.13 | 5.82 |
| 21 | 5.64 | 5.67 | 5.99 | 5.8 |
| 22 | 5.76 | 5.56 | 5.97 | 5.74 |
| 23 | 5.62 | 5.82 | 5.97 | 5.81 |
| 24 | 5.72 | 5.71 | 5.99 | 5.76 |
| 25 | 5.74 | 5.55 | 5.92 | 5.73 |
| 26 | 5.74 | 5.69 | 5.91 | 5.77 |
| 27 | 5.81 | 5.53 | 6.07 | 5.82 |
| 28 | 5.76 | 5.71 | 5.89 | 6.13 |
| 29 | 5.58 | 5.66 | 5.97 | 5.7 |
| 30 | 5.74 | 5.65 | 5.9 | 5.71 |
| 31 | 5.72 | 5.66 | 5.95 | 5.78 |
| 32 | 5.66 | 5.67 | 6.05 | 5.78 |
| 33 | 5.86 | 5.74 | 6.03 | 5.79 |
| 34 | 5.73 | 5.65 | 6.03 | 5.75 |
| 35 | 5.86 | 5.74 | 6.06 | 5.77 |

TABLE 3
Weight trials (18 mg)
The weights are from the second run with the new filters
The capsules were produced at 120 cpm machine speed
(=36,000 capsules per minute)
Samples were taken after each 2 minutes during the run
Target 18 mg (Maximum achievable with the existing cylinder)

| | Track 1 | Track 2 | Track 3 | Track 4 | Track 5 |
|---|---|---|---|---|---|
| | 18 | 18.32 | 18.55 | 18.75 | 18.6 |
| | 18.32 | 18.55 | 18.8 | 18.7 | 18.72 |
| | 17.72 | 18.05 | 18.63 | 18.28 | 19.01 |
| | 18.02 | 18.15 | 18.6 | 18.37 | 18.75 |
| Average (per track) | 18.02 | 18.27 | 18.65 | 18.53 | 18.77 |
| Overall average | 18.44 | | | | |
| Standard Dev. | 0.25 | 0.22 | 0.11 | 0.23 | 0.17 |
| (per Track) | | | | | |

| | |
|---|---|
| Overall Standard Dev. | 0.33 |

Table 4 and Table 5 below outline the composition of the stevia product according to the invention (ReelPur™) and a few portioned stevia products currently available on the market. As can be seen, none of the products currently available on the market contains stevia extract alone.

TABLE 4
Comparing a few stevia products

| | ReelPur ™ | | | | | | | |
|---|---|---|---|---|---|---|---|---|
| | (product | | | Stevia in | | | | |
| | according to | | | the | Walt | Sugar | President | Skinny |
| Brand | the invention) | PureVia ™ | Truvia ™ | Raw ™ | Mart ™ | Lantic ™ | Choice ™ | Girl ™ |
| Product | ReelPur | PureVia | Truvia | In The | Great | Lantic | PC Stevia | Skinnygirl |
| | Stevia | | | Raw | Value | Stevia | | Organic |
| | | | | | Stevia | | | Stevia |
| Ingredients list | Stevia leaf | Dextrose, | Erythritol, | Dextrose, | Erythritol, | Erythritol, | Erythritol, | Organic |
| | extract | Steviol | stevia leaf | Stevia | Stevia | Stevia leaf | natural | dextrose, |
| | (100%) | glycosides | extract, | Glycosides | extract | extract | stevia extract, | Organic |
| | | (28 mg), | natural | | leaf, | (Natural | Flavour | stevia |
| | | cellulose | flavors | | Flavour | polyol), | | |
| | | powder, | | | | Natural | | |
| | | Flavors | | | | flavours | | |
| High intensity | Stevia | Stevia | Stevia | Stevia | Stevia | Stevia | Stevia | Stevia |
| ingredient | | | | | | | | |
| Base ingredient | Stevia | Corn | Corn | Corn | Corn | Corn | Corn | Corn |
| | | dextrose | erythritol | Dextrose | Dextrose | Dextrose | Dextrose | Dextrose |
| Serving size (mg) | 16.5 | 1000 | 3000 | 1000 | 2000 | 1800 | 2000 | 1000 |
| % Pur stevia in | 100% | 2.8% | <3% | <3% | <2% | <1% | <2% | <2% |
| product | | | | | | | | |
| Other added | 0 | 97.2% | >95% | >97% | >98% | >99% (120 | >98% | >98% |
| ingredients | | (59 times) | (180 times) | (58 times) | (120 | times) | (120 times) | (59 times) |
| (ReelPur cap. | | | | | times) | | | |
| weight | | | | | | | | |
| equivalent) | | | | | | | | |

TABLE 5
Comparing a few stevia products

| | ReelPur ™ | | | | | | | |
|---|---|---|---|---|---|---|---|---|
| | (product | | | | | | | |
| | according to | | Sugar | | | | Sweet | Whole |
| Brand | the invention) | Exact ™ | Twin ™ | Greeniche ™ | Weider ™ | Equate ™ | Leaf ™ | Earth ™ |
| Product | ReelPur | Exact | Sugar Twin | Stevia The | Stevia Sweet | Equate Stevia | Organic | Starbucks |
| | Stevia | Stevia | Stevia | Gold | | | Stevia | WHOLE |
| | | | | | | | | EARTH |
| Ingredients list | Stevia leaf | Maltodextrin, | Erythritol, | Erythritol, | Maltodextrine, | Maltodextrine, | Inulin, | Erythritol, |
| | extract | Stevia extract | 14 mg | Stevia extract | Stevia, Talin | Steviol | Organic | Fructose, |
| | (100%) | | Stevia | (99.8%) | RMD90, | glycosides | stevia | Chicory Root |
| | | | extract | rebaudioside | Vitamin C | | extract | Fiber, Stevia |
| | | | per ½ | A), Silicon | | | | Leaf Extract, |
| | | | packet (1 g), | Dioxide | | | | Monk Fruit |
| | | | Flavours | | | | | Extract |
| High intensity | Stevia | Stevia | Stevia | Stevia | Stevia | Stevia | Stevia | Stevia, Monk |
| ingredient | | | | | | | | fruit |
| Base ingredient | Stevia | Maltodextrine | Corn | Corn | Maltodextrine | Maltodextrine | Inulin | Corn |
| | | | Erythritol | Erythritol | | | | Erythritol |
| Serving size (mg) | 16.5 | 1000 | 2000 | 1500 | 600 | 1000 | 1000 | 2000 |
| % Pure stevia in | 100% | 3.3% | <2% | <3% | <4.75% | <3% | <3% | <2% |
| Product | | | | | | | | |
| Other added | 0 | >96.7% (58.5 | >98% | >97% (89 | >95% (35 | >97% (59 | >97% (59 | >98% |
| ingredients | | times) | (59.75 | times) | times) | times) | times) | (59.75 |
| (ReelPur cap. | | | times) | | | | | times) |
| weight | | | | | | | | |
| equivalent) | | | | | | | | |

The capsule is adapted to be operated manually by a user, such as to release the stevia extract, into a cup for example.

As will be understood by a skilled person, a capsule may be presented such that the sweetness of its content is equivalent to the sweetness of, for example, half a sugar cube or tablespoon, as desired.

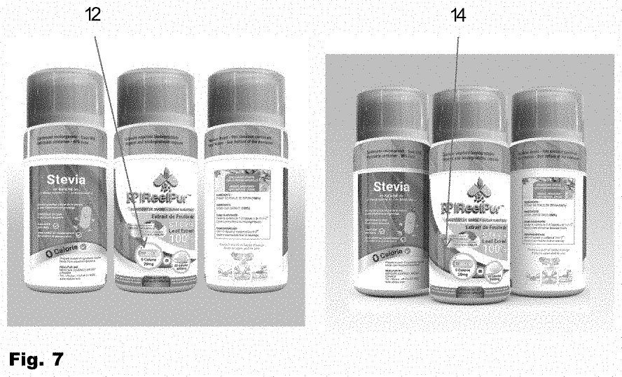

Also, as will be understood by a skilled person, a plurality of capsules according to the invention may be offered in a container (FIG. 7). Such container may be for example a capsule distributor. A user may operate the container with both hands, or with a single hand. In the specific embodiment illustrated in FIG. 7, the containers on the left comprise white capsules (12) and the containers on the right comprise green capsules (14).

Indeed, in embodiments of the invention, the capsule may have a color selected from the group consisting of: white, green, brown, colourless, yellow, red, blue, black, ivory, orange, grey, pink, pearly blue, and combinations thereof. Optionally, the capsule is opaque or transparent. In further embodiments, a sign printed may be printed on an external surface of the capsule (FIG. 4B). Optionally the sign is selected from the group consisting of: image of a human face, image of an object, group of letters, words, and combinations thereof.

As indicated above, a capsule 1 (FIG. 3 and FIG. 4A) is provided. The capsule is filled with pure (about 100%) stevia extract 10. An amount of the stevia extract in the capsule is: between about 6 to 8 mg, between about 8 to 10 mg, between about 10 to 12 mg, between about 12 to 14 mg, between about 13 to 15 mg, between about 13.5 to 16.5 mg, preferably between about 14 to 17 mg, preferably between about 15 to 19 mg, preferably between about 16 to 20 mg, preferably between about 17 to 21 mg, preferably between about 18 to 22 mg, preferably between about 19 to 23 mg, preferably between about 20 to 24 mg, preferably between about 21 to 25 mg, preferably between about 22 to 26 mg, or between about 6.5 to 8.5 mg, etc. The invention also allows to fill 100% pure stevia extract for an equivalent sweetness of sugar/saccharose from one cube (or tablespoon) to multiple sugar cubes (2, 3, 4, 5 . . . 10. etc. as desired) in a capsule for various food applications, such as for example bakery at home.

In embodiments of the invention, the amount of the stevia extract in the capsule is between about 13.5 to 16.5 mg or multiple of these weights (example between 27 to 33 mg or 40.5 to 49.5 mg, etc).

In embodiments of the invention, the amount of the stevia extract in the capsule is between about a multiple of the amount 13.5 to 16.5 mg, for example 27 to 33 mg, 40.5 to 49.5 mg, 54 to 66 mg etc as desired.

In embodiments of the invention, the amount of the stevia extract in the capsule is between about 6.5 to 8.5 mg.

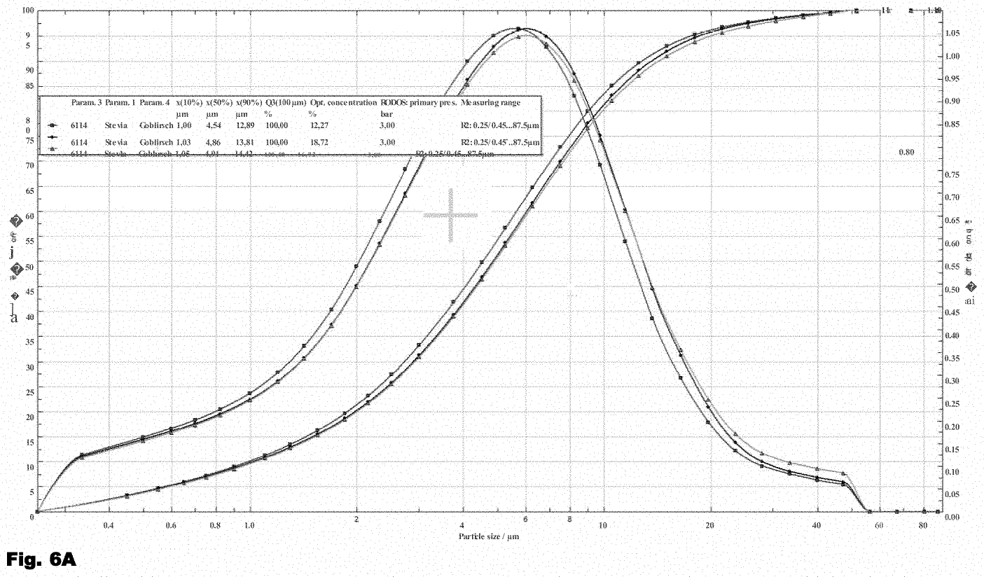

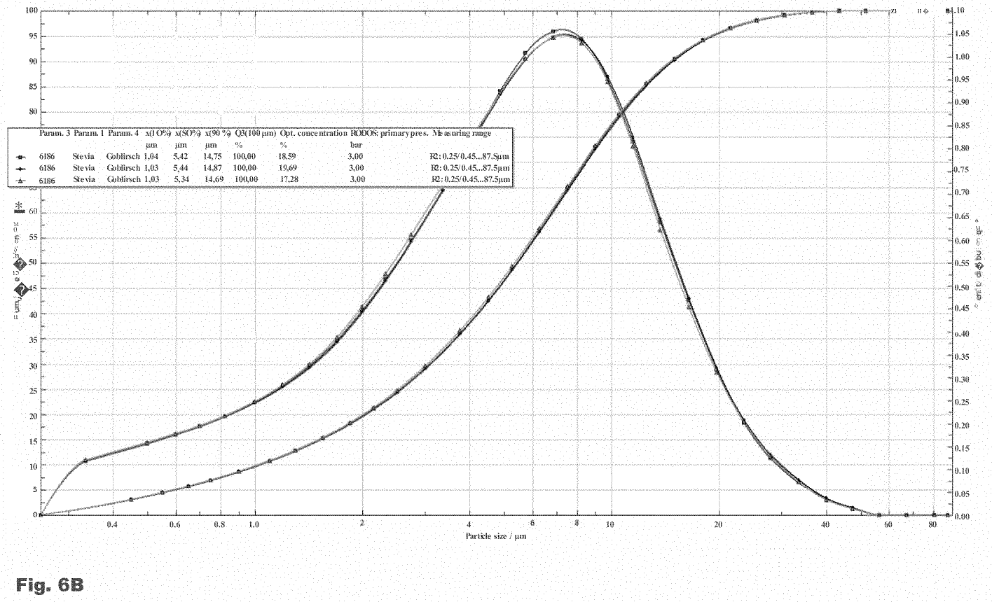

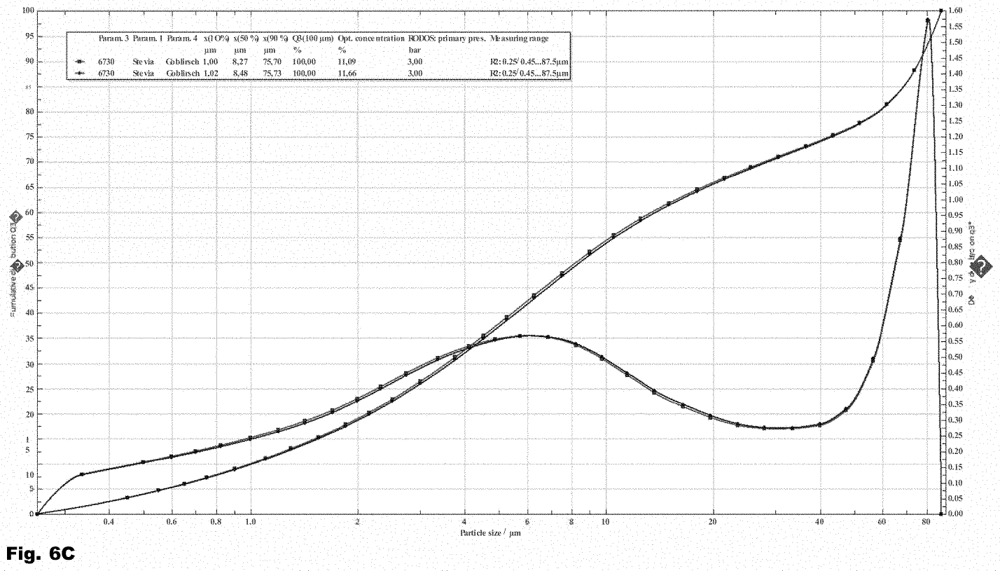

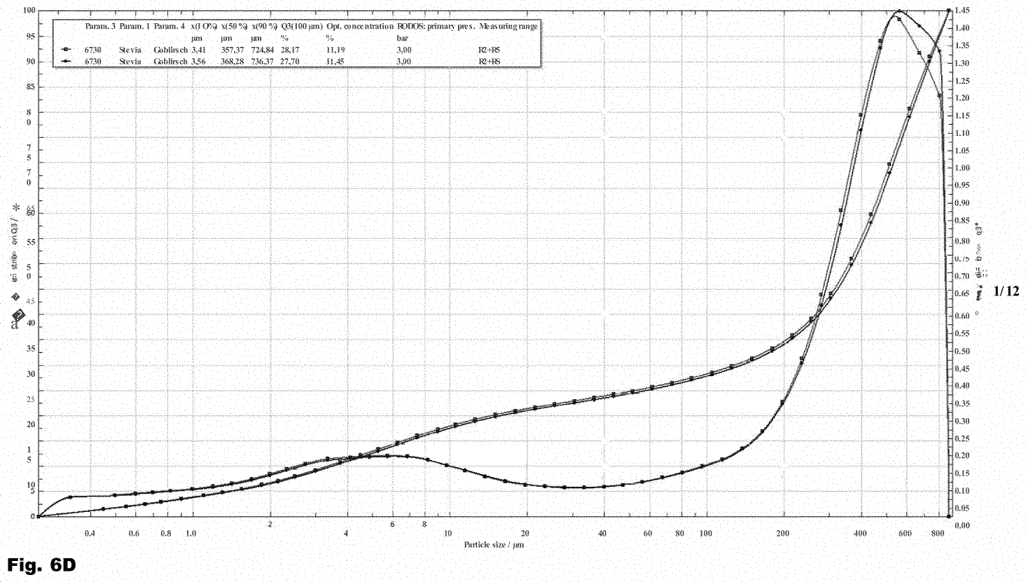

In embodiments of the invention, the stevia extract is in powder form (FIG. 3). The particles of the powder have specific sizes. The particles sizes of the stevia extract in powder form are illustrated in FIGS. 6A-6D and Table 6 below. FIG. 6A and FIG. 6B relate to stevia powder in substantially bulk form. FIG. 6A shows that in sample Stevia 6114, 90% of the particles have sizes of up to about 14.42 microns; and FIG. 6B shows that in sample Stevia 6186, 90% of the particles have sizes of up to about 14.87 microns. After the granulation process, the particles size increases—indeed, FIG. 6C shows that in sample Stevia 6730, 90% of the particles have sizes of up to about 75.73 microns. A further increase of the particles size is observed after a subsequent tamping process—indeed, FIG. 6D shows that in sample Stevia 6730 (tamped), 90% of the particles have sizes up of to about 724.84 microns. The tamped stevia powder is suitably portioned, for example packaged into capsules.

Accordingly, granulation coupled with tamping allows to solve the low-density challenging constraint and package associated with bulk 100% pure stevia powder. In embodiments of the invention, the tamping process is performed directly on bulk 100% pure stevia extract powder with no granulation process being performed. In other words, the granulation process may or may not be performed. In fact, without tamping the powder dosing during filling and sugar equivalent sweetness would be inconsistent, and the bulk 100% pure stevia extract powder will not be releasable from its packaging (capsule in this case)

As will be understood by a skilled person, the granulation process and the tamping process may be performed using techniques known in the art.

As will be understood by a skilled person, the stevia extract may also be in a form which is liquid, granular, pieces of dry leaf, or a combination thereof.

TABLE 6
Particles sizes of the stevia extract

| Product | | ×10 [μm] | ×50 [μm] | ×90 [μm] |
|---|---|---|---|---|
| 6114 Stevia | Mean | 1.03 | 4.77 | 13.71 |
| | SD | 0.03 | 0.20 | 0.77 |
| 6186 Stevia | Mean | 1.03 | 5.40 | 14.77 |
| | SD | 0.01 | 0.05 | 0.09 |
| 6730 Stevia | Mean | 3.49 | 362.83 | 730.61 |
| | SD | 0.11 | 7.71 | 8.15 |

In embodiments of the invention, the capsule is made of a material which is: hydroxypropyl methyl cellulose (HPMC) hydroxymethyl cellulose (HMC), gelatin, pullulan naturally fermented from tapioca, vegetable-based material, or a combination thereof. Optionally, the material is bio-degradable. In embodiments of the invention, the material may be soluble in aqueous medium. In other embodiments of the invention, the material may be insoluble in aqueous medium.

In embodiments of the invention, the capsule has an elongated spherical shape. A length of the capsule may be between about 7 to 100 mm and a width between about 3 to 28 mm; preferably a length between about 10 to 90 mm and a width between about 4 to 25 mm; preferably a length between about 11.1 to 88.5 mm and a width between about 4.91 to 23.4 mm. Table 7 below outlines the various dimensions and sizes of the capsule according to the invention.

TABLE 7
Size, shape, and other physical attributes of generic
tablets and capsules

| | Volume | Closed length | External diameter |
|---|---|---|---|
| Size | (mL) | (mm) | (mm) |
| 5 | 0.13 | 11.1 | 4.91 |
| 4 | 0.21 | 14.3 | 5.31 |
| 3 | 0.30 | 15.9 | 5.82 |
| 2 | 0.37 | 18 | 6.35 |
| 1 | 0.50 | 19.4 | 6.91 |
| 0 | 0.68 | 21.7 | 7.65 |
| 0E | 0.7 | 23.1 | 7.65 |
| 00 | 0.95 | 23.3 | 8.53 |
| 000 | 1.37 | 26.14 | 9.91 |
| 13 | 3.2 | 30 | 15.3 |
| 12 | 5 | 40.5 | 15.3 |
| 12el | 7.5 | 57 | 15.5 |
| 11 | 10 | 47.5 | 20.9 |
| 10 | 18 | 64 | 23.4 |
| 7 | 24 | 78 | 23.4 |
| Su07 | 28 | 88.5 | 23.4 |

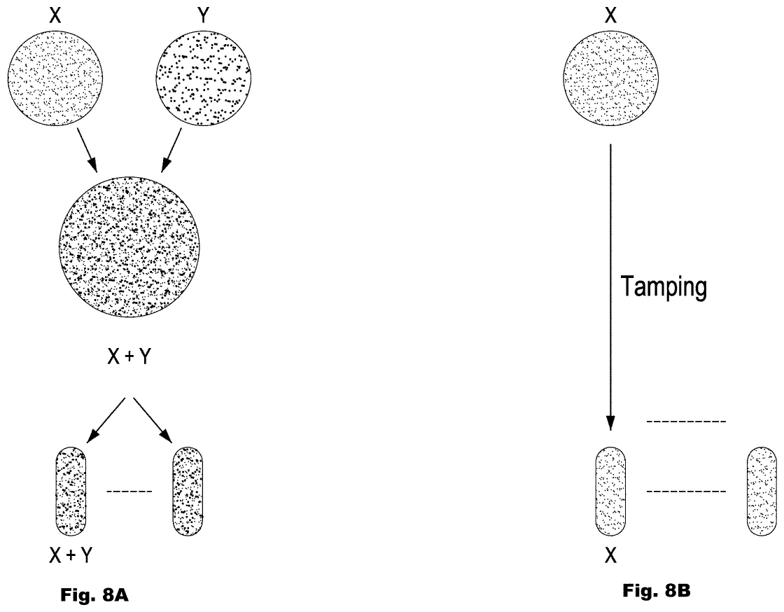

Referring to FIG. 8A, a process for obtaining a stevia product known in the art and currently presented to consumers is illustrated. In such process, pure stevia extract powder (X) is mixed with other ingredients such as probiotics (Y), then the mixture (X+Y) is portioned. Accordingly, the ultimate product presented to consumers, while containing pure stevia, does also contained other ingredients. Indeed, the amount of pure stevia extract in the products of the prior art is typically less than 2-5%.

FIG. 8B illustrates the process according to the invention. As can be seen, bulk pure stevia extract powder (X) is subjected to a tamping process (optionally, a physical granulation process is performed prior to the tamping process). Then the tamped powder obtained (X′) is portioned, i.e., inserted into capsules. Accordingly, a capsule according to the invention contains pure stevia extract as the sole ingredient, in tamped form (X′). In other words, the amount of pure stevia in the product according to the invention is 100%. In embodiments of the invention, the contain of a capsule has a sweetness which is equivalent of the sweetness of a sugar cube or tablespoon.

As outlined herein, the tamping process yields a compacted pure stevia extract powder, which allows for its insertion into the capsule. Given the particularly low density of bulk pure stevia extract powder, its direct insertion into a capsule presents some significant challenges. This problem is solved in the prior art by mixing bulk pure stevia extract powder with other ingredients (fillers). Such solution is completely different from the solution of the present invention which consists of subjecting bulk pure stevia extract powder to tamping.

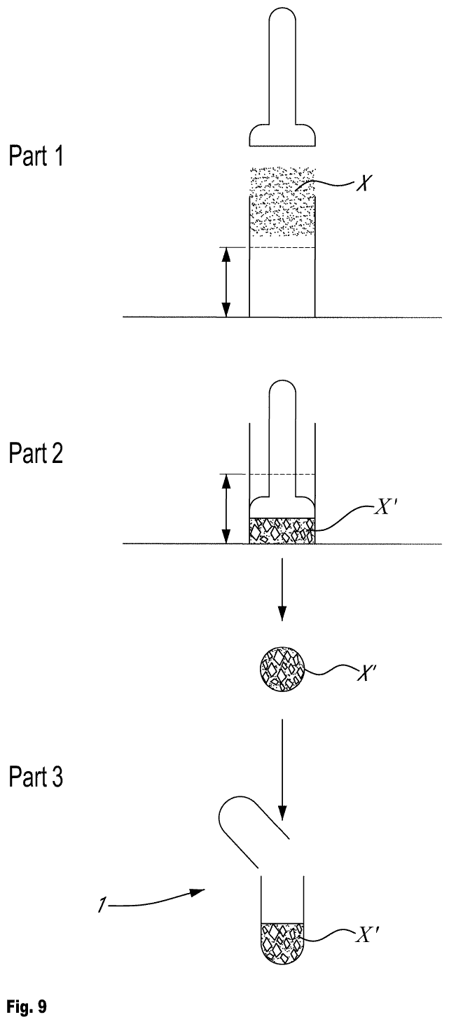

Referring to FIG. 9, the tamping process is illustrated. Part 1 illustrates the filling—bulk pure stevia extract powder (X) or stevia extract powder “untamped” is poured into a powder chamber which comprises a closing plate. An initial height of the bulk powder into the chamber (powder height) is illustrated. A pestle for compacting the powder is also illustrated. Part 2 of the figure illustrates the tamping itself. The pestle compacts the powder yielding a tamped powder (X′) or stevia extract “tamped”. A height of the tamped powder is illustrated, which is smaller than the original height. Part 3 of the figure illustrates the packaging. The closing plate is removed and the tamped powder (X′) in the form of slugs, is released into a capsule. In embodiments of the invention, the contain of a capsule has a sweetness which is equivalent of the sweetness of a sugar cube or tablespoon (13.5 mg).

As will be understood by a skilled person, 100% pure stevia extract in tamped form may be presented in a relatively large container, and a user may use a device, such as a spoon or the like, to retrieve a desired amount.

As will be understood by a skilled person, the invention thus provides a method of making readily available to consumers a stevia extract that is about 100% pure, preferably in portioned form.

As will be understood by a skilled person, the capsule according to the invention may further comprise at least one other product, for example having a nutritional value to consumers. Such other product may be for example a nutritional supplement, a vitamin, a flavor. In this embodiment, the amount of the stevia in the product is more than about 60%.

As will be understood by a skilled person, the presentation and packaging according to the invention may be applied to other sweeteners presenting challenges similar to stevia extract. Such sweeteners may include, but are not limited to, extracts of other plants and artificially prepared products.

The scope of the claims should not be limited by the preferred embodiments set forth in the examples; but should be given the broadest interpretation consistent with the description as a whole.

The present description refers to a number of documents, the content of which is herein incorporated by reference in their entirety.

1. A capsule containing a single ingredient which is 100% pure stevia extract in tamped powder form, wherein 90% of particles have sizes up to about 724.84 microns, wherein the content of the capsule has a sweetness which is equivalent to the sweetness of a sugar cube or a tablespoon of sugar, and wherein the stevia extract is obtained by a process comprising a step of tamping bulk 100% pure stevia extract powder and inserting the tamped powder into the capsule.

2. The capsule according to claim 1, wherein the process further comprises a physical granulation step which is performed prior to the tamping step.

3. A capsule containing a single ingredient which is 100% pure stevia extract in a tamped powder form, wherein 90% of particles have sizes up to about 724.84 microns; wherein the amount of the stevia extract in the capsule is: between about 6 to 8 mg, between about 8 to 10 mg, between about 10 to 12 mg, between about 12 to 14 mg, between about 13 to 15 mg, between about 13.5 to 16.5 mg, between about 14 to 17 mg, between about 15 to 19 mg, between about 16 to 20 mg, between about 17 to 21 mg, between about 18 to 22 mg, between about 19 to 23 mg, between about 20 to 24 mg, between about 21 to 25 mg, between about 22 to 26 mg, or between about 6.5 to 8.5 mg; and wherein the stevia extract is obtained by a process comprising a step of tamping bulk 100% pure stevia extract powder and inserting the tamped powder into the capsule.

4. The capsule according to claim 3, wherein the process further comprises a physical granulation step which is performed on the bulk powder prior to the tamping step.

5. The capsule according to claim 3, wherein the amount of the stevia extract in the capsule is between about 13.5 to 16.5 mg.

6. The capsule according to claim 3, wherein the amount of the stevia extract in the capsule is between about a multiple of the amount 13.5 to 16.5 mg.

7. The capsule according to claim 3, wherein the amount of the stevia extract in the capsule is about 13.5 mg or about 27 mg.

8. The capsule according to claim 3, wherein the amount of the stevia extract in the capsule is between about 27 to 33 mg, 40.5 to 49.5 mg, 54 to 66 mg, 67.5 to 82.5, or 81 to 99 mg.

9. The capsule according to 1, wherein the capsule is made of a material selected from the group consisting of: hydroxypropyl methyl cellulose (HPMC) hydroxymethyl cellulose (HMC), gelatin, pullulan naturally fermented from tapioca, vegetable-based material, and combinations thereof.

10. The capsule according to 1, wherein the capsule is made of a material that is bio-degradable.

11. The capsule according to 1, wherein the capsule is made of a material that is soluble in aqueous medium.

12. The capsule according to claim 1, wherein the capsule is made of a material that is not soluble in aqueous medium.

13. The capsule according to claim 1, wherein the process comprises filing the bulk 100% pure stevia extract powder into a chamber comprising a closing plate, compacting the powder using a pestle to yield the tamped powder, and removing the closing plate thereby releasing the tamped powder into the capsule.

14. The capsule according to claim 13, wherein, into the chamber, a height of tamped powder is smaller than an initial height of the bulk powder.

15. A package comprising one or more capsules as defined in claim 1.

16. A portioned single ingredient which is 100% pure stevia extract in tamped powder form, having a sweetness which is equivalent to the sweetness of a sugar cube or a tablespoon of sugar; and wherein 90% of particles of the stevia extract have sizes up to about 724.84 microns; and wherein the stevia extract is obtained by a process comprising a step of tamping bulk 100% pure stevia extract powder.
